(19) United States
(12) Patent Application Publication
(10) Pub. No.: US 2019/0179464 A1
(43) Pub. Date: Jun. 13, 2019

(54) TOUCH PANEL APPARATUS FOR RECEIVING USER OPERATION

(71) Applicant: KYOCERA Document Solutions Inc., Osaka (JP)

(72) Inventor: Junichi FUKUOKA, Osaka (JP)

(73) Assignee: KYOCERA Document Solutions Inc., Osaka (JP)

(21) Appl. No.: 16/214,073

(22) Filed: Dec. 8, 2018

(30) Foreign Application Priority Data
Dec. 8, 2017 (JP) 2017-235731

(51) Int. Cl. G06F 3/041; G06F 3/044; G06F 3/0488

(52) U.S. Cl. CPC G06F 3/0412; G06F 3/0488; G06F 3/044; G06F 3/0416

(57) ABSTRACT

Provided is a touch panel apparatus that receives a user operation even when a touch panel cannot accurately detect the touch position. A display unit displays an input screen on which a plurality of operation keys is arranged. A touch sensor detects contact on the input screen and outputs coordinates corresponding to a position where contact is detected. A normal-input-receiving unit receives an operation on the input screen based on a detection result of the touch sensor. A screen-control unit displays a cursor for selecting an operation key in the case where the normal-input-receiving unit cannot detect an operation based on the detection result of the touch sensor. A cursor-operation-receiving unit receives a cursor operation for moving the cursor based on the detection result of the touch sensor while the cursor is being displayed.

### INCORPORATION BY REFERENCE

This application is based on and claims the benefit of priority from Japanese Patent Application No. 2017-235731 filed on Dec. 8, 2017, the contents of which are hereby incorporated by reference.

### BACKGROUND

The present disclosure relates to a touch panel apparatus for receiving user operation.

As a typical technique, there is known a technique in which, by performing a pre-registered cursor appearance operation, a cursor is displayed in the vicinity of a finger contacting a touch panel. In this technique, the cursor is moved by flicking the cursor with a finger. After the cursor has been moved to a desired icon position, the display screen is tapped. As a result, the processing of the icon where the cursor is positioned is executed. Accordingly, operation is possible even in a state where a portable terminal such as a smartphone or the like is held with only one hand.

### SUMMARY

The touch panel apparatus according to the present disclosure includes a display unit, a touch sensor, a normal-input-receiving unit, a screen-control unit and a cursor-operation-receiving unit. The display unit displays an input screen on which a plurality of operation keys is arranged. The touch sensor detects contact on the input screen and outputs coordinates corresponding to a position where contact is detected. The normal-input-receiving unit receives an operation on the input screen based on a detection result of the touch sensor. The screen-control unit displays a cursor for selecting the operation key in the case where the normal-input-receiving unit cannot detect an operation based on the detection result of the touch sensor. The cursor-operation-receiving unit receives a cursor operation for moving the cursor based on a detection result of the touch sensor while the cursor is being displayed.

### BRIEF DESCRIPTION OF THE DRAWINGS

FIG. 1 is a functional block diagram illustrating a schematic configuration of a touch panel apparatus of an embodiment according the present disclosure.

FIG. 2 is an example of registration of normal-operation information illustrated in FIG. 1.

FIG. 3 is a normal operation example registered in the normal-operation information illustrated in FIG. 2.

FIG. 4 is an example of registration of cursor-operation information illustrated in FIG. 1.

FIG. 5 is an example of a cursor operation registered in the cursor-operation information illustrated in FIG. 4.

FIG. 6 is a flowchart illustrating a flow of an operation-key-selection process of the touch panel apparatus illustrated in FIG. 1.

### DETAILED DESCRIPTION

In the following, embodiments of the present disclosure will be described in detail with reference to the drawings. Incidentally, in the following embodiments, the same reference numbers are given to the configurations having similar functions.

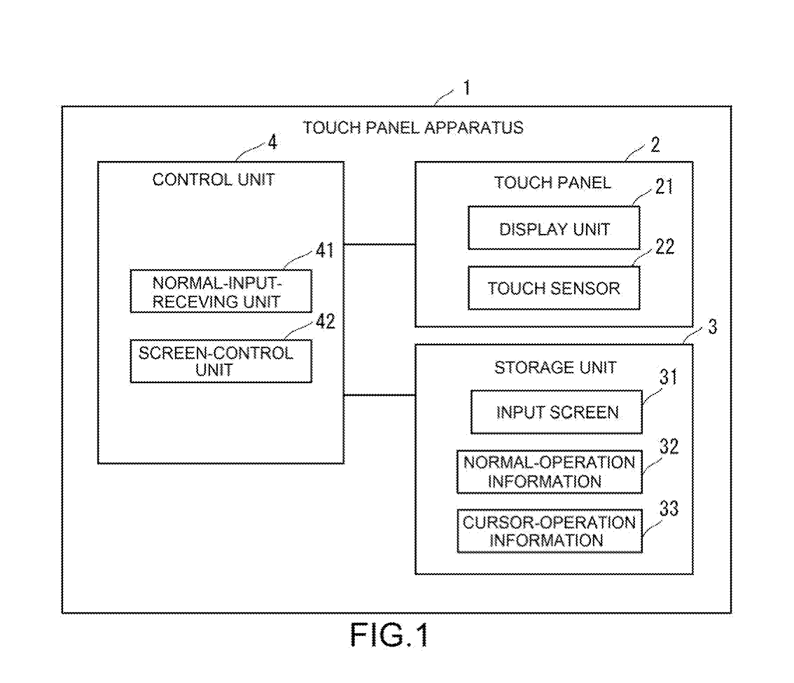

As illustrated in FIG. 1, a touch panel apparatus 1 includes a touch panel 2, a storage unit 3, and a control unit 4.

The touch panel 2 includes a display unit 21 and a touch sensor 22. The display unit 21 displays an input screen 31 for receiving various input from a user. As the display unit 21 it is possible to use a liquid-crystal display, an organic EL display, a plasma display, electronic paper, or the like. The touch sensor 22 is formed into a transparent sheet shape and is arranged on the upper surface of the display unit 21. The touch sensor 22 is a position input device that detects a position on the display unit 21 the user contacts with a finger or the like and outputs coordinates corresponding to the position to the control unit 4. As the touch sensor 22, it is possible to use a touch sensor of an electrostatic capacitance type, an ultrasonic type, a pressure sensitive type, a resistive film type, a light detection type, or the like.

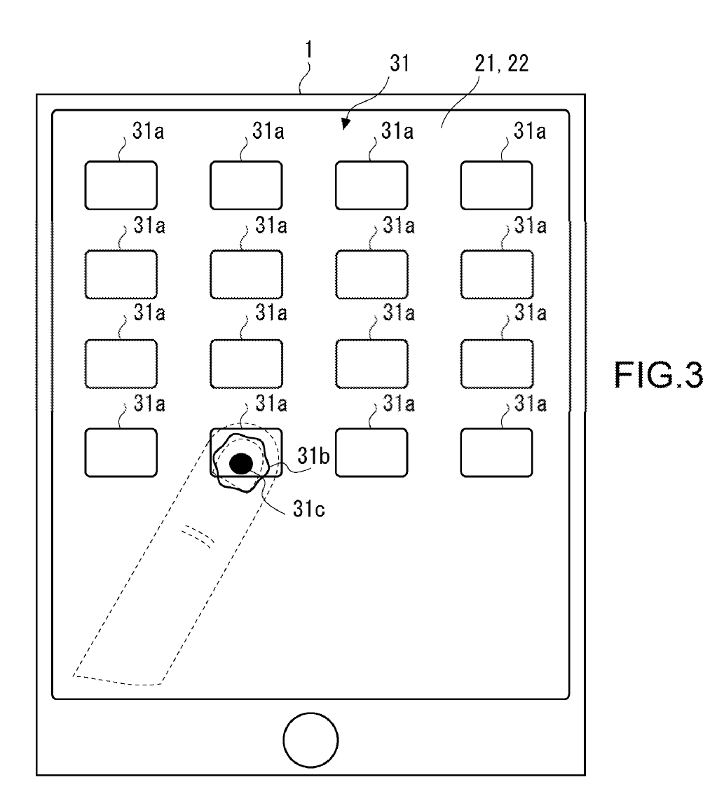

The storage unit 3 is a nonvolatile memory such as a flash memory or the like. The storage unit 3, for example, stores an input screen 31 on which a plurality of operation keys (refer to FIG. 3) 31a is arranged as an input screen 31 to be displayed on the display unit 21. In addition, the storage unit 3 stores normal-operation information 32 in which normal operation on the input screen 31 is registered, and cursor-operation information 33 in which cursor operation on the input screen 31 is registered.

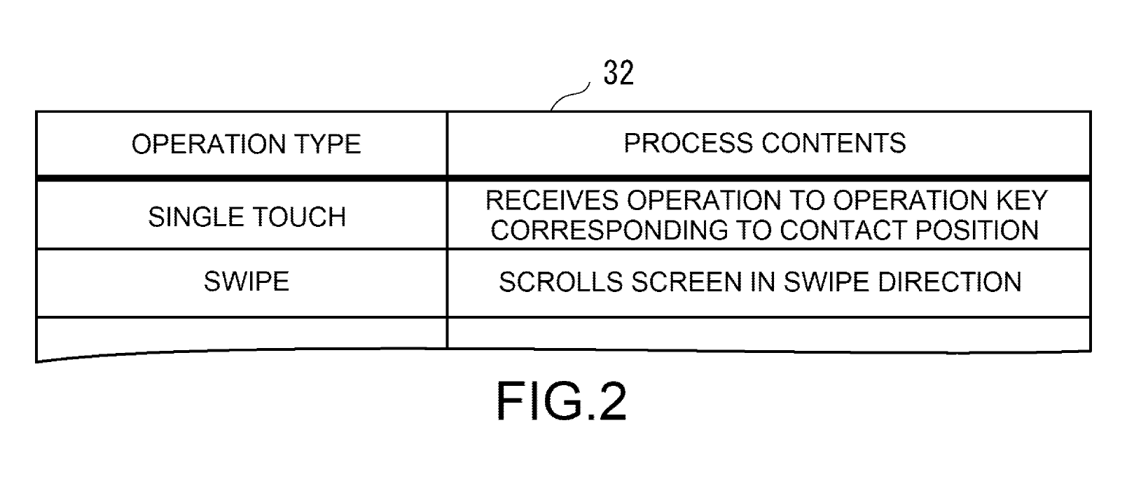

FIG. 2 illustrates an example of registration of the normal-operation information 32. As the normal operation, a single touch for touching one location on the input screen 31, or a swipe for moving a finger or the like while touching one location on the input screen 31, are registered. As illustrated in FIG. 3, when a single touch is detected, the touch sensor 22 outputs coordinates 31c on the input screen 31 corresponding to the position where the contact 31b is detected. Then, operation of an operation key 31 corresponding to the coordinates 31c is received. As a result, a process assigned to the operation key 31a, for example, activation of an application, input of a character, or the like is executed. In the case where a swipe is detected, the screen is scrolled in the swipe direction based on the coordinates of the movement direction of the finger or the like outputted by the touch sensor 22.

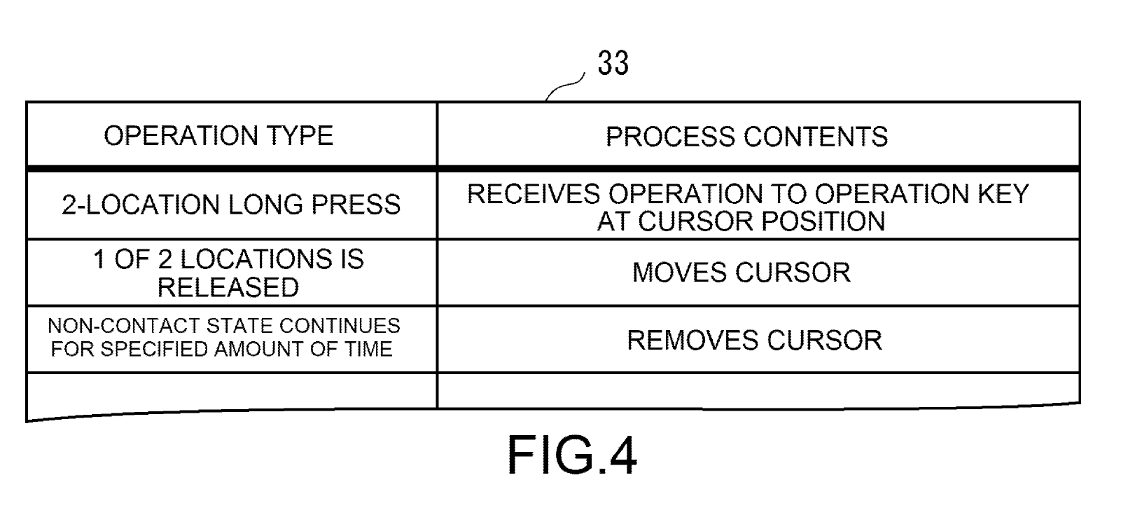

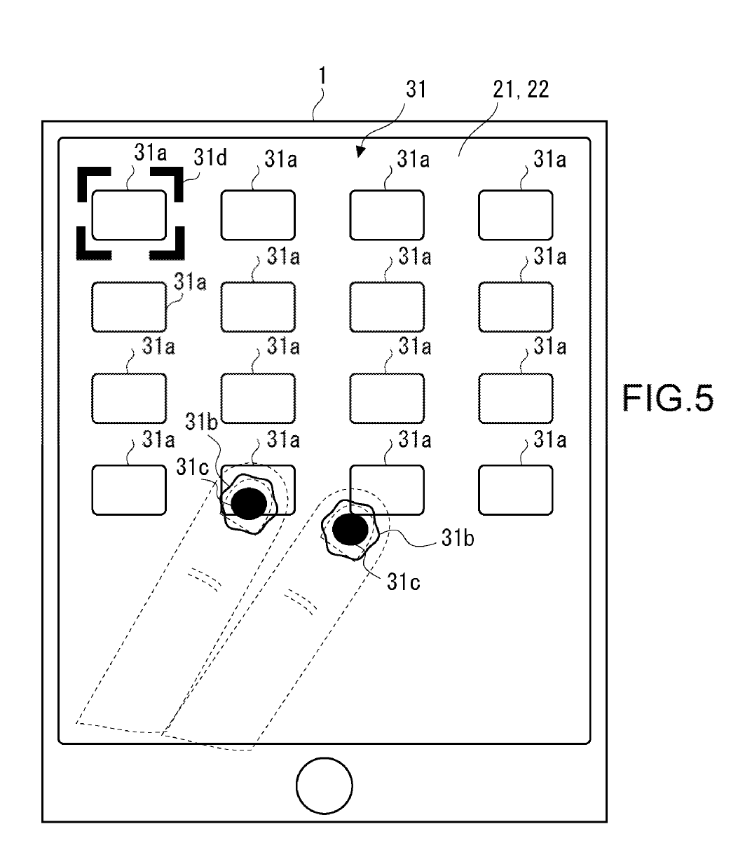

FIG. 4 illustrates an example of registration of the cursor-operation information 33. As the cursor operation, operations such pressing two locations for a long time on the input screen 31, releasing one location out of two contact locations on the input screen 31, continuation of the non-contact state of the input screen 31 for a specified amount of time, and the like are registered. As illustrated in FIG. 5, in the case where two locations are pressed for a long time, regardless of the coordinates 31c of the two locations, the operation of the operation key 31a where the cursor 31d is positioned is received. As a result, a process assigned to the operation key 31a such as activation of an application, character input, or the like is executed. In the case where one location of two locations of contact 31b is released, the cursor 31d moves to one of the adjacent operation keys 31a. In the case where a specific amount of time elapses with no contact on the input screen 31, the cursor 31d disappears.

The control unit 4 is an information processing unit such as a microcomputer or the like including a central processing unit (CPU), a read only memory (ROM), a random access memory (RAM), and the like. The ROM stores a control program for controlling the operation of the touch panel apparatus 1. The control unit 4 reads the control program stored in the ROM, develops the control program in the RAM, and executes the control program, thereby controlling the entire apparatus. In addition, the control unit 4 functions as a normal-input-receiving unit 41 and a screen-control unit 42.

The normal-input-receiving unit 41 has a function of detecting an operation registered in the normal operation information 32 or the cursor-operation information 33 based on the detection result of the touch sensor 22 and receiving the detected operation. For example, in a normal operation mode (normal-operation mode), for example, the normal-input-receiving unit 41 detects an operation (hereinafter referred to as a “normal operation”) registered in the normal-operation information 32 based on the detection result of the touch sensor 22, and receives the normal operation. As a normal operation, the normal-input-receiving unit 41 receives an operation of an operation key 31a on the input screen 31 based on the coordinates 31c outputted from the touch sensor 22.

In the case where the normal-input-receiving unit 41 cannot detect the normal operation based on the detection result of the touch sensor 22, the normal-input-receiving unit 41 switches to the cursor-operation mode. In the cursor-operation mode, the normal-input-receiving unit 41 functions as a cursor-operation-receiving unit, and receives a cursor operation based on contact with the input screen 31 regardless of the coordinates 31c outputted from the touch sensor 22.

In the case where the normal-input-receiving unit 41 is set to the cursor-operation mode, the screen-control unit 42 described later displays the cursor 31d on one of the plurality of operation keys 31a on the input screen 31. While the cursor 31d is displayed on the input screen 31, the normal-input-receiving unit 41 detects the operation (cursor operation) registered in the cursor-operation information 33 as the cursor-operation mode and receives the cursor operation. In the cursor operation, the operation key 31a where the cursor 3d is located is selected regardless of the coordinates 31c outputted from the touch sensor 22.

For example, in the normal-operation mode, in the case where the touch sensor 22 detects that one place on the input screen 31 has been touched, the normal-input-receiving unit 41 detects a single-touch operation registered in the normal-operation information 32. Moreover, in the normal-operation mode, in the case where in a state in which contact 31b is detected at one location on the input screen 31, and the detected position of this contact 31b is detected to have moved by a specific distance or more on the input screen 31, the normal-input-receiving unit 41 detects a swipe registered in the normal-operation information 32. In the case where a single touch is detected, the screen is updated corresponding to the function of the operation key 31a corresponding to the coordinates 31c outputted from the touch sensor 22, and in the case where a swipe is detected, the screen is scrolled in the swipe direction based on the coordinates 31c outputted from the touch sensor 22. In this way, in the normal-operation mode, in either case operation processing is executed based on the coordinates 31c outputted by the touch sensor 22 is executed.

On the other hand, operations such as an operation of contact at two locations on the input screen 31, a contact operation of a plurality of operation keys at the same time, or a contact operation of solid contact over a wide area such as pressing the entire palm against the input screen 31, are not registered in the normal-operation information 32. In the case where this kind of an irregular operation is performed, the normal-input-receiving unit 41 cannot detect the operation registered in the normal-operation information 32 based on the detection result of the touch sensor 22, and switches to the cursor-operation mode.

In the cursor-operation mode, in the case where, in a state of there being contact at two locations on the input screen 31 and the touch sensor 22 detects that one location of the two locations has been released, the normal-input-receiving unit 41 detects a cursor-movement operation based on the cursor-operation information 33. In addition, in the case where it is detected by the touch sensor 22 that two locations on the input screen 31 have been pressed for a long time, the normal-input-receiving unit 41 detects a cursor-setting operation based on the cursor-operation information 33. In the case where the touch sensor 22 detects that there has been no contact on the input screen 31 for a specified amount of time, a cursor-removal operation is detected based on the cursor-operation information 33.

In the cursor-movement operation, the screen-control unit 42 moves the cursor 31d displayed on the input screen 31 to an adjacent operation key 31a. Incidentally, the screen is also automatically scrolled by the screen-control unit 42 as necessary so that the operation key 31a where the cursor 31d is located is not outside the display screen. In the cursor-setting operation, the operation of the operation key 31a where the cursor 31d is positioned is received, and the screen is updated to the screen corresponding to the function of the operation key 31a. In addition, in the cursor-removal operation, the screen-control unit 42 removes the cursor 31d displayed on the input screen 31, and the normal-input-receiving unit 41 returns to the normal-operation mode. In this way, in the cursor-operation mode, the normal-input receiving unit 41 in any case receives the cursor operation based on the state of the contact detected by the touch sensor 22 regardless of the coordinates 31c outputted by the touch sensor 22. Then, the operation key 31a is selected via the cursor operation, and the process assigned to the operation key 31a where the cursor 31d is positioned is executed.

The screen-control unit 42 has a function of displaying the input screen 31 on the display unit 21 and controlling the screen based on operation detected by the normal-input-receiving unit 41. For example, in the case where the normal-input-receiving unit 41 fails to detect a normal operation based on the detection result of the touch sensor 22, the screen-control unit 42 displays the cursor 31d for selecting the operation key 31a on the input screen 31.

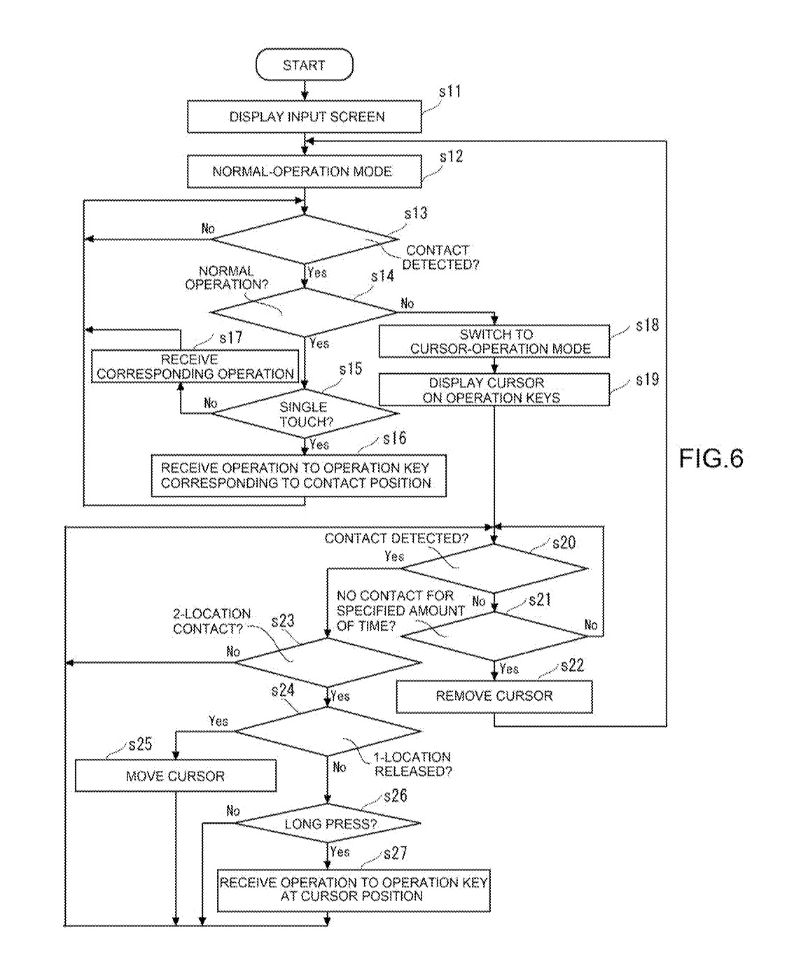

Next, with reference to FIG. 6, the flow of the operation-key-selection process of the touch panel apparatus 1 will be explained.

When the screen-control unit 42 displays the input screen 31 on the display unit 21 (S11), the normal-input-receiving unit 41 is set to the normal-operation mode (S12) and waits until the touch sensor 22 detects that a user contacts the input screen 31 with a finger or the like (S13, S13: NO). In the normal-operation mode, the normal-input-receiving unit 41 detects an operation on the input screen 31 based on the normal-operation information 32.

When the touch sensor 22 detects contact 31b on the input screen 31 (S13: YES), the normal-input-receiving unit 41 determines whether or not normal operation is detected based on the detection result of the touch sensor 22 (S14). In the case where the detection result of the touch sensor 22 corresponds to an operation registered in the normal-operation information 32, the operation is detected as a normal operation.

In the case where a normal operation is detected (S14: YES), and in the case where the detected normal operation is a single touch (S15: YES), the normal-input-receiving unit 41, based on the normal-operation information 32, receives the operation of the operation key 31a corresponding to the position of the contact 31b (S16) and returns to the process is S13. As a result, the process assigned to the operation key 31a corresponding to the coordinates 31c outputted from the touch sensor 22 is executed. In the case where, the detected normal operation is not a single touch (S15: NO), the normal-input-receiving unit 41 receives the corresponding operation based on the normal-operation information 32 (S17) and returns the process to S13. As a result, for example, a swipe operation is received and screen scrolling is executed.

On the other hand, in the case where normal operation cannot be detected (S14: NO), or in other words, in the case where an irregular operation is performed on the input screen 31, the normal-input-receiving unit 41 switches to the cursor-operation mode (S18). Then, via the screen-control unit 42, the cursor 31d is displayed on any one of the plurality of operation keys 31a (S19). As a result, in the case where a user who is not able to execute an intended operation performs a messy operation, the cursor operation can be performed as an alternative method of normal operation. For example, this is a case in which a malfunction occurs in the touch sensor 22, the coordinates 31c outputted from the touch sensor 22 are inaccurate, or the coordinates 31c are not outputted. In the cursor-operation mode, the normal-input-receiving unit 41 detects an operation on the input screen 31 based on the cursor-operation information 33.

Continuing, the normal-input-receiving unit 41, via the touch sensor 22, determines whether or not contact 31b on the input screen 31 is detected (S20). In the case where contact 31b on the input screen 31 is not detected (S20: NO), the normal-input-receiving unit 41 determines whether or not the input screen 31 has remained in a non-contact for a specified amount of time (for example, 3 minutes) (S21). In the case where the non-contact state has not continued for the specified amount of time (S21: NO), the process returns to S20.

On the other hand, when the input screen 31 has remained in the non-contact state for a specified amount of time (S21: YES), the normal-input-receiving unit 41 detects the cursor-removal operation based on the cursor-operation information 33. Via the screen control unit 42, the cursor 31d displayed on the input screen 31 is removed (S22), and the process returns to S12 that is the normal-operation mode. As a result, the cursor-operation mode ends.

On the other hand, in the case where the touch sensor 22 detects the contact 31b on the input screen 31 (S20: YES), the normal-input-receiving unit 41, via the touch sensor 22, determines whether or not there is contact on the input screen 31 at two locations (S23). For example, in the case where the detected contact 31b is one location and not two locations (S23: NO), the process returns to S20. This is because an operation corresponding to the cursor-operation information 33 is not registered.

In the case where there is contact at two locations (S23: YES), the normal-input-receiving unit 41, via the touch sensor 22, determines whether or not one of the two contact 31b locations detected is released (S24). In the case where one location is released (S24: YES), the normal-input-receiving unit 41 detects a cursor-movement operation based on the cursor-operation information 33. Then, the screen-control unit 42 moves the cursor 31d to an adjacent operation key 31a (S25), and returns the process to S20. This cursor-movement operation allows the user to move the cursor 31d to the position of a desired operation key 31a regardless of the coordinates 31c outputted from the touch sensor 22. Incidentally, the cursor movement route in the case where the cursor-movement operation is performed may be preset.

On the other hand, in the case where one location of the two contact 31b locations is not released (S24: NO), the normal-input-receiving unit 41, via the touch sensor 22, determines whether or not the contact state at the two locations is a long press (S26). In the case where the contact state is not a long press (S26: NO), for example, in the case where two locations are touched and released quickly, the normal-input-receiving unit 41 returns the process to S20. This is because an operation corresponding to the cursor-operation information 33 is not registered.

On the other hand, in the case where two locations are long pressed (S26: YES), the normal-input-receiving unit 41 detects a cursor-setting operation based on the cursor-operation information 33, receives the operation to the operation key 31a where the cursor 31d is located (S27) and returns the process to S20. As a result, the user can reliably operate the operation key 31a where the cursor 31d is located, regardless of the coordinates 31c outputted from the touch sensor 22.

Incidentally, in the case where the normal-input-receiving unit 41 receives an operation to the operation key 31a, the process in S16 is returned to S13, and the process in S27 is returned to S20, however, the process of this flowchart may end without returning the respective processes.

In this way, the touch panel apparatus 1 includes: a display unit 21 for displaying an input screen 31 on which a plurality of operation keys 31a are arranged; a touch sensor 22 that detects a contact 31b on the input screen 31 and outputs coordinates 31c corresponding to the position where the contact 31b is detected; a normal-input-receiving unit 41 that receives an operation on the input screen 31 based on the detection result of the touch sensor 22; a screen-control unit 42 that displays a cursor 31d for selecting an operation key 31a in the case where the normal-input-receiving unit 41 fails to detect an operation based on the detection result of the touch sensor 22; and a cursor-operation-receiving unit (normal-input-receiving unit 41) that, while the cursor 31d is displayed, receives a cursor operation for moving the cursor 31d based on the detection result of the touch sensor 22. As a result, in the case where the user cannot perform a desired touch operation and the normal-input-receiving unit 41 cannot detect an operation on the input screen 31, the cursor 31d is displayed. This makes it possible to receive the cursor operation by the user. The case when the user cannot perform a desired touch operation is that, for example, incorrect coordinates are outputted or coordinates are not outputted from the touch sensor 22. Therefore, it is possible to provide a touch panel apparatus 1 with high usability.

Moreover, in the case where the normal-input-receiving unit 41 switches to the cursor-operation mode, the control unit 4 may function as an operation-guidance unit that displays the operation method of the cursor 31d on the display unit 21 or guides the operation method by voice from a speaker. As a result, even in the case where the touch sensor 22 fails and the cursor 31d is suddenly displayed on the input screen 31, the user can grasp the current state and continue the current operation.

In the typical technique described above, there is a problem that in a case where the portable terminal is dropped or submerged causing trouble in the touch panel to occur so that the touch panel cannot detect the contact position accurately, the cursor operation cannot be performed.

With the technique according to the present disclosure, even in the case where the touch panel cannot accurately detect the touch position, it is possible to receive a user operation.

The technique according to the present disclosure is not limited to the above-described embodiments, and it goes without saying that various modifications can be made within a range not departing from the gist of the present disclosure.

What is claimed is:

1. A touch panel apparatus comprising:
a display unit that displays an input screen on which a plurality of operation keys are arranged;
a touch sensor that detects contact on the input screen and outputs coordinates corresponding to a position where contact is detected;
a normal-input-receiving unit that receives an operation on the input screen based on a detection result of the touch sensor;
a screen-control unit that displays a cursor for selecting the operation key in the case where the normal-input-receiving unit cannot detect an operation based on a detection result of the touch sensor;
a cursor-operation-receiving unit that receives a cursor operation for moving the cursor based on a detection result of the touch sensor while the cursor is being displayed.

2. The touch panel apparatus according to claim 1, wherein
the normal-input-receiving unit receives an operation of the operation key on the input screen based on the coordinates outputted from the touch sensor.

3. The touch panel apparatus according to claim 1, wherein
the cursor-operation-receiving unit receives the cursor operation based on contact with the input screen regardless of the coordinates.

4. The touch panel apparatus according to claim 1, wherein
the normal-input-receiving unit, in the case where two locations of contact on the input screen are detected by the touch sensor, does not detect an operation on the input screen, and the screen-control unit displays the cursor.

5. The touch panel apparatus according to claim 1, wherein
the normal-input-receiving unit, in the case where the touch sensor detects simultaneous contact to a plurality of operation keys, does not detect an operation on the input screen, and the screen-control unit displays the cursor.

6. The touch panel apparatus according to claim 1, further comprising
an operation-guidance unit for guiding the operation method of the cursor in the case where the cursor is displayed on the input screen.
